(19) United States
(12) Patent Application Publication
(10) Pub. No.: US 2026/0086721 A1
(43) Pub. Date: Mar. 26, 2026

(54) FLASH MEMORY APPARATUS AND ERASING METHOD THEREOF

(71) Applicant: Winbond Electronics Corp., Taichung City (TW)

(72) Inventor: Cheng Han Lee, Taichung (TW)

(73) Assignee: Winbond Electronics Corp., Taichung City (TW)

(21) Appl. No.: 19/017,793

(22) Filed: Jan. 13, 2025

(30) Foreign Application Priority Data
Sep. 26, 2024 (TW) 113136668

(51) Int. Cl. G06F 3/06

(52) U.S. Cl. CPC G06F 3/0616; G06F 3/0659; G06F 3/0679

(57) ABSTRACT

A flash memory apparatus and an erasing method thereof are provided. The flash memory apparatus includes a memory array and a memory control circuit. The memory array includes multiple memory blocks. The memory control circuit is configured to pull an erase voltage applied to a target memory block of the multiple memory blocks from a reference voltage value up to an erase voltage value during an erase operation, and after an erase time, reduce the erase voltage from the erase voltage value in two discharge stages.

### CROSS-REFERENCE TO RELATED APPLICATION

This application claims the priority benefit of Taiwan application serial no. 113136668, filed on Sep. 26, 2024. The entirety of the above-mentioned patent application is hereby incorporated by reference herein and made a part of this specification.

### BACKGROUND

### Technical Field

The disclosure relates to a memory apparatus, and in particular to a flash memory apparatus prolonging service life and an erase method thereof.

### Description of Related Art

The cycling operation consists of an erase operation and a programming operation. After multiple cycles, electrons accumulate on the oxide sidewalls in a flash memory, leading to an increase in threshold voltage and a decrease in the current flowing between the source and drain. As a result, more incremental step pulse erase (ISPE) operations are required, bringing more and more challenges to passing the erase verification.

Due to the configurations, the issue of increasing threshold voltage is more pronounced on dummy word lines compared to regular word lines. The more cycles are performed, the more severe the degradation becomes, eventually leading to a situation where electrons can no longer be removed, causing failure to pass the erase verification.

### SUMMARY

The disclosure provides a flash memory apparatus and an erasing method, which can dynamically reduce the erase voltage in two discharge stages, thereby mitigating the degradation of dummy word lines.

The flash memory apparatus of the disclosure includes a memory array and a memory control circuit. The memory array includes multiple memory blocks. The memory control circuit is coupled to the memory array and is configured to pull the erase voltage applied to a target memory block of the multiple memory blocks from a reference voltage value up to an erase voltage value during an erase operation, and after an erase time, reduce the erase voltage from the erase voltage value in two discharge stages.

The erasing method of the flash memory apparatus includes the following steps. During the erase operation, the erase voltage applied to a target memory block of the multiple memory blocks is pulled from a reference voltage value up to an erase voltage value, and after an erase time, the erase voltage is reduced from the erase voltage value in two discharge stages.

Based on the above, the flash memory apparatus and its erasing method can reduce the erase voltage in two discharge stages. In this way, the increase in threshold voltage and the degradation of the dummy word lines may be slowed down, thereby extending the service life of the flash memory apparatus.

### BRIEF DESCRIPTION OF THE DRAWINGS

FIG. 1 illustrates a schematic overview of a flash memory apparatus according to an embodiment of the disclosure.

FIG. 2 illustrates a partial schematic view of a target memory block according to an embodiment of the disclosure.

FIG. 3 illustrates a flowchart of the steps of an erasing method for a flash memory apparatus according to an embodiment of the disclosure.

FIG. 4 illustrates a waveform diagram of an erase operation for a flash memory apparatus according to an embodiment of the disclosure.

### DESCRIPTION OF THE EMBODIMENTS

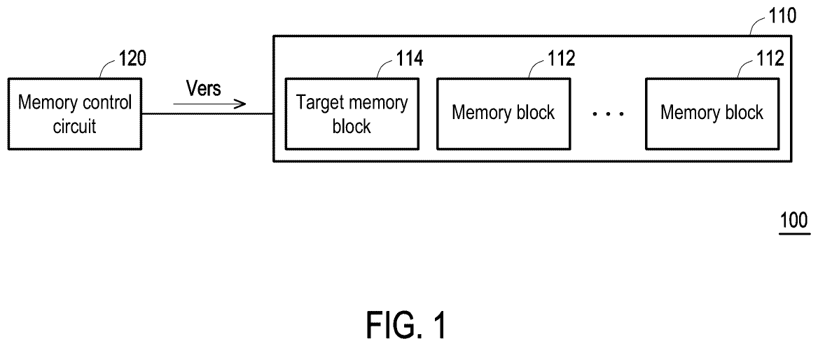

Referring to FIG. 1, a flash memory apparatus 100 in an embodiment of the disclosure may be, for example, NAND type or NOR type, and includes a memory array 110 and a memory control circuit 120. The memory array 110 includes multiple memory blocks 112. Each memory block 112 includes multiple memory cells. In this embodiment of the disclosure, there are no limitations on the number of memory blocks 112 or memory cells.

The memory control circuit 120 is coupled to the memory array 110. The memory control circuit 120 is used to select a target memory block 114 from the memory blocks 112 in the memory array 110 according to a selection command to execute a designated operation. FIG. 1 illustrates the memory control circuit 120 located in the flash memory apparatus 100, but the memory control circuit 120 may also be a device independent of the flash memory apparatus 100.

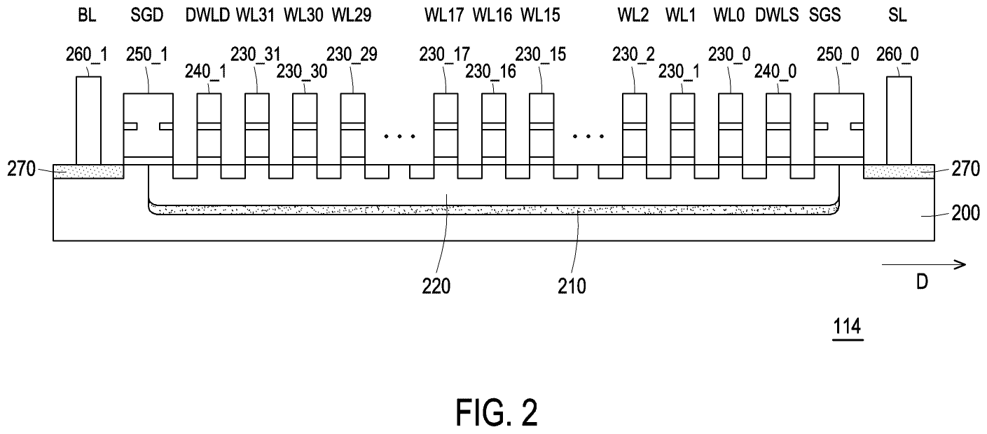

Referring to FIG. 2, the target memory block 114 includes a substrate 200, a first well region 210, a second well region 220, first conductors 230_0 to 230_31, second conductors 240_0 and 240_1, third conductors 250_0 and 250_1, and fourth conductors 260_0 and 260_1. In FIG. 2, the substrate 200 has a first conductivity type, the first well region 210 has a second conductivity type, and is disposed on the substrate 200. The second well region 220 has the first conductivity type and is disposed on the first well region 210. The first conductivity type may be P-type, and the second conductivity type may be N-type. However, the disclosure is not limited to this, as long as the first and second conductivity types are complementary.

The first conductors 230_0 to 230_31 are disposed on the second well region 220. The first conductors 230_0 to 230_31 are configured to be respectively coupled to word lines WL0 to WL31. The second conductors 240_0 and 240_1 are also disposed on the second well region 220. The second conductors 240_0 and 240_1 are configured to be respectively coupled to dummy word lines DWLS and DWLD. The third conductors 250_0 and 250_1 are disposed at positions adjacent to the second well region 220 and the substrate 200. The third conductors 250_0 and 250_1 are configured to be respectively coupled to a first select gate line SGS and a second select gate line SGD. The fourth conductors 260_0 and 260_1 are disposed on a doped region 270 in the surface region of the substrate 200. The doped region 270 has the second conductivity type and is configured to be respectively coupled to a bit line BL and a source line SL.

In a planar direction D, the second conductor 240_0, which is coupled to the dummy word line DWLS, is configured between the first conductor 230_0, which is coupled to the word line WL0, and the third conductor 250_0. The second conductor 240_1, which is coupled to the dummy word line DWLD, is disposed between the first conductor 230_1, which is coupled to the word line WL1, and the third conductor 250_1. In other words, the dummy word lines DWLS and DWLD are positioned on the outer sides of word lines WL0 to WL31. As a result, due to their configurations, the etching load on DWLS and DWLD is more significant than on other word lines, making the issue of increasing threshold voltage more pronounced on the dummy word lines DWLS and DWLD than on word lines WL0 to WL31.

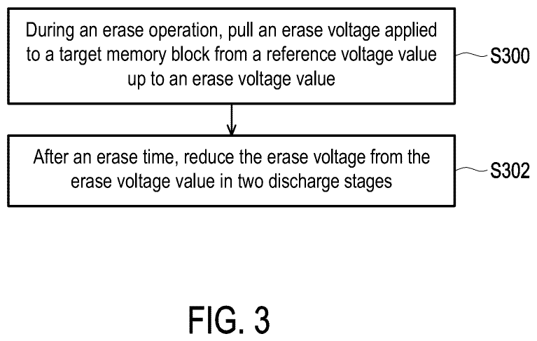

Referring simultaneously to FIGS. 1, 2, and 3, the erasing method of the flash memory apparatus in this embodiment applies to the flash memory apparatus 100 shown in FIG. 1. The steps of the erasing method in this embodiment are described below in conjunction with the components of the flash memory apparatus 100.

In step S300, during the erase operation, the memory control circuit 120 pulls an erase voltage Vers applied to the target memory block 114 from a reference voltage value VR up to an erase voltage value VWW. During the erase operation, the memory control circuit 120 may apply the erase voltage Vers to the second well region 220 of the target memory block 114.

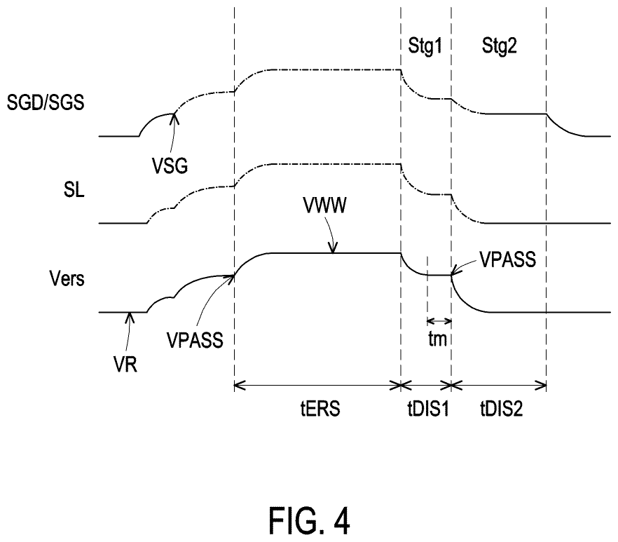

FIG. 4 shows the voltage waveforms of the erase voltage Vers applied to the second well region 220, the source line SL, the first select gate line SGS, and the second select gate line SGD. The vertical axis represents voltage values, and the horizontal axis represents time. As shown in FIG. 4, during the erase operation, the memory control circuit 120 pulls the erase voltage Vers applied to the target memory block 114 from the reference voltage value VR up to the erase voltage value VWW. When the erase voltage Vers is raised above a pass voltage value VPASS, the data stored in the target memory block 114 begins to be erased, and this point in time can be regarded as the starting point of an erase time tERS.

In step S302, after the erase time tERS, the memory control circuit 120 reduces the erase voltage Vers from the erase voltage value VWW in two discharge stages. In a first discharge stage Stg1, the memory control circuit 120 reduces the erase voltage Vers from the erase voltage value VWW to the pass voltage value VPASS. As shown in FIG. 4, after the erase voltage value VWW is reduced to the pass voltage value VPASS, the erase voltage Vers is maintained at the pass voltage value VPASS for a maintenance time tm. In practical applications, the erase time tERS may be, for example, 350 microseconds, and the maintenance time tm may be, for example, 20microseconds, but the disclosure is not limited to this. In a second discharge stage Stg2, the memory control circuit 120 reduces the erase voltage Vers from the pass voltage value VPASS to the reference voltage value VR.

A first discharge time tDIS1 spent in the first discharge stage Stg1 ranges from 0.01 times the block erase time to 1 time the block erase time. A second discharge time tDIS2 spent in the second discharge stage Stg2 is less than 1 time the block erase time. In practical applications, the first discharge time tDIS1 may be, for example, 40 microseconds, and the second discharge time tDIS2 may be, for example, 50 microseconds. Additionally, during the erase operation, both the first discharge stage Stg1 and the second discharge stage Stg2 are performed for discharging the second well region 220.

By reducing the erase voltage Vers in two discharge stages, the pressure difference per unit of time can be improved, effectively reducing the intensity of the electric field generated, thereby slowing down the increase in the threshold voltage. Moreover, the two-stage discharge of the erase voltage Vers is based on the existing pass voltage value VPASS, which offers advantages in reducing chip area and manufacturing costs.

The erase voltage value VWW is greater than the pass voltage value VPASS, and the pass voltage value VPASS is greater than the reference voltage value VR. In practical applications, the erase voltage value VWW may be, for example, 19 volts, the pass voltage value VPASS may be, for example, 9 volts, and the reference voltage value VR may be, for example, 0 volts, but the disclosure is not limited to these values.

Additionally, during the erase operation, the bit line BL and the source line SL are in a floating state. The first select gate line SGS and the second select gate line SGD are in a floating state after being pulled up to a select voltage value VSG. In FIG. 4, the floating states of the source line SL, the first select gate line SGS, and the second select gate line SGD are represented by dashed lines.

During the erase operation, the potentials of the source line SL, the first select gate line SGS, and the second select gate line SGD change according to the potential of the second well region 220 due to a coupling effect. As shown in FIG. 4, the potentials of the source line SL, the first select gate line SGS, and the second select gate line SGD in the floating state change along with the erase voltage Vers applied to the target memory block 114.

In summary, the flash memory apparatus and its erasing method of the disclosure can reduce the erase voltage in two discharge stages. In this way, the intensity of the electric field generated can be effectively reduced, and the electrons trapped during cycling operations can be minimized. This helps to slow down the increase in threshold voltage and the degradation of dummy word lines, thereby extending the service life of the flash memory apparatus.

What is claimed is:

1. A flash memory apparatus, comprising:
a memory array, comprising a plurality of memory blocks; and
a memory control circuit, coupled to the memory array and configured to pull an erase voltage applied to a target memory block of the plurality of memory blocks from a reference voltage value up to an erase voltage value during an erase operation, and after an erase time, reduce the erase voltage from the erase voltage value in two discharge stages.

2. The flash memory apparatus according to claim 1, wherein the memory control circuit reduces the erase voltage from the erase voltage value to a pass voltage value in a first discharge stage, and reduces the erase voltage from the pass voltage value to the reference voltage value in a second discharge stage, wherein the erase voltage value is greater than the pass voltage value, and the pass voltage value is greater than the reference voltage value.

3. The flash memory apparatus according to claim 2, wherein a range of a first discharge time spent in the first discharge stage is between 0.01 times a block erase time and 1 times the block erase time, and a second discharge time spent in the second discharge stage is less than 1 times the block erase time.

4. The flash memory apparatus according to claim 1, wherein the target memory block comprises:
a substrate, having a first conductivity type;
a first well region, having a second conductivity type and disposed on the substrate;
a second well region, having the first conductivity type and disposed on the first well region;
a plurality of first conductors, disposed on the second well region and configured to be respectively coupled to a plurality of word lines;
a plurality of second conductors, disposed on the second well region and configured to be respectively coupled to a plurality of dummy word lines;
two third conductors, disposed at a position where the second well region is adjacent to the substrate, and configured to be respectively coupled to a first select gate line and a second select gate line; and
two fourth conductors, disposed on a doped region in a surface region of the substrate, and configured to be respectively coupled to a bit line and a source line.

5. The flash memory apparatus according to claim 4, wherein in a planar direction, the second conductor coupled to the dummy word line is configured between the first conductor coupled to the word line and the third conductor.

6. The flash memory apparatus according to claim 4, wherein during the erase operation, the bit line and the source line are in a floating state, and the first select gate line and the second select gate line are in the floating state after being pulled up to a select voltage value.

7. The flash memory apparatus according to claim 4, wherein during the erase operation, the memory control circuit applies the erase voltage to the second well region.

8. The flash memory apparatus according to claim 4, wherein during the erase operation, a potential of the source line, the first select gate line, and the second select gate line changes with a potential of the second well region due to a coupling effect.

9. The flash memory apparatus according to claim 4, wherein the first conductivity type is P-type, and the second conductivity type is N-type.

10. An erasing method for a flash memory apparatus, wherein the flash memory apparatus comprises a plurality of memory blocks, the erasing method comprising:
pulling an erase voltage applied to a target memory block of the plurality of memory blocks from a reference voltage value up to an erase voltage value during an erase operation; and
after an erase time, reducing the erase voltage from the erase voltage value in two discharge stages.

11. The erasing method according to claim 10, wherein reducing the erase voltage from the erase voltage value in the two discharge stages after the erase time comprises:
reducing the erase voltage from the erase voltage value to a pass voltage value in a first discharge stage; and
reducing the erase voltage from the pass voltage value to the reference voltage value in a second discharge stage, wherein the erase voltage value is greater than the pass voltage value, and the pass voltage value is greater than the reference voltage value.

12. The erasing method according to claim 11, wherein a range of a first discharge time spent in the first discharge stage is between 0.01 times a block erase time and 1 times the block erase time, and a second discharge time spent in the second discharge stage is less than 1 times the block erase time.

13. The erasing method according to claim 10, wherein the target memory block comprises:
a substrate, having a first conductivity type;
a first well region, having a second conductivity type and disposed on the substrate;
a second well region, having the first conductivity type and disposed on the first well region;
a plurality of first conductors, disposed on the second well region and configured to be respectively coupled to a plurality of word lines;
a plurality of second conductors, disposed on the second well region and configured to be respectively coupled to a plurality of dummy word lines;
two third conductors, disposed at a position where the second well region is adjacent to the substrate, and configured to be respectively coupled to a first select gate line and a second select gate line; and
two fourth conductors, disposed on a doped region in a surface region of the substrate, and configured to be respectively coupled to a bit line and a source line.

14. The erasing method according to claim 13, wherein in a planar direction, the second conductor coupled to the dummy word line is configured between the first conductor coupled to the word line and the third conductor.

15. The erasing method according to claim 13, wherein during the erase operation, the bit line and the source line are in a floating state, and the first select gate line and the second select gate line are in the floating state after being pulled up to a select voltage value.

16. The erasing method according to claim 13, wherein during the erase operation, the erase voltage is applied to the second well region.

17. The erasing method according to claim 13, wherein during the erase operation, a potential of the source line, the first select gate line, and the second select gate line changes with a potential of the second well region due to a coupling effect.

18. The erasing method according to claim 13, wherein the first conductivity type is P-type, and the second conductivity type is N-type.
